(19) United States
(12) Patent Application Publication
(10) Pub. No.: US 2020/0327873 A1
(43) Pub. Date: Oct. 15, 2020

(54) ELECTRIC BAGPIPE AND ELECTRIC BAGPIPE COMPONENTS

(71) Applicant: David Emmanuel Alves DUNCAN, Los Angeles, CA (US)

(72) Inventor: David Emmanuel Alves DUNCAN, Los Angeles, CA (US)

(21) Appl. No.: 16/845,674

(22) Filed: Apr. 10, 2020

Related U.S. Application Data
(60) Provisional application No. 62/834,142, filed on Apr. 15, 2019.

(51) Int. Cl. G10H 3/16; G10D 7/06; G10D 9/035; G10H 3/14

(52) U.S. Cl. CPC G10H 3/16; G10D 7/06; G10H 2220/525; G10H 3/143; G10D 9/035

(57) ABSTRACT

The present invention relates to an electric pickup device for a bagpipe drone. The present invention also relates to an electric pickup device for a bagpipe chanter. The invention also relates to an electric bagpipe comprising a blowstick, a bag, at least one drone having an electric pickup sensor spaced 0.5-5 mm from the drone reed and a chanter having an electric pickup device with a sensor spaced 0.5-5 mm from the chanter reed.

This application claims the benefit of the filing date of U.S. Provisional Application Ser. No. 62/834,142 filed 18 Apr. 2019.

### BACKGROUND

Bagpipes are a woodwind instrument which use enclosed reeds. There are numerous variations of bagpipes. A traditional bagpipe typically consists of an air reservoir (bag), a blowpipe (or bellows) for filling the bag with air, one or more drone pipes, a set of reeds, and one or more chanter pipes. The instrumentalist blows air into the bag through the blowpipe and squeezes the air out of the bag into the drone and chanter pipes which are all attached to the bag via connecting pipes called stocks. Each drone and chanter pipe contains a reed within the stock over which air passes as it escapes the bag out through the pipes. Typically, a drone reed is a single reed which is structurally different from a chanter reed which is a double reed. The passage of air over the reeds causes the reeds to vibrate and produce sound, which is in turn altered by the either the length of each drone pipe or by the hole placement in the case of the chanter pipe. The chanter is the melody pipe and is typically played with two hands. Almost all bagpipes have at least one chanter and some bagpipes have two chanters. Almost all bagpipes have at least one drone and most bagpipes have multiple drones. The drone pipe is typically not fingered but rather produces a constant harmonizing note throughout play

### BRIEF DESCRIPTION OF THE DRAWINGS

Various features and attendant advantages of the present invention will be more fully appreciated as the same becomes better understood when considered in conjunction with the accompanying drawings, in which like reference characters designate the same or similar parts throughout the several views, and wherein:

FIG. 1 depicts a typical traditional bagpipe.

FIG. 2 depicts a chanter embodiment of the present invention.

FIG. 3 depicts a drone embodiment of the present invention.

FIG. 4 depicts a traditional drone reed (42) with a tongue (41).

FIG. 5 depicts a traditional double chanter reed (80)

FIG. 6a shows an embodiment of the present invention where the chanter sensor (92) tip is bent towards the chanter reed (80).

FIG. 6b shows embodiment of the present invention where the drone sensor (50) is slightly spaced from the drone reed (42).

FIG. 7a shows embodiment of the present invention where the chanter sensor (92) is spaced apart from the chanter reed (80).

FIG. 7b shows embodiment of the present invention where the drone sensor (50) is spaced apart from a drone reed (42).

### SUMMARY OF THE INVENTION

The present invention is directed to an electric bagpipe comprising a blowstick (10) for delivering air to a bag (20) which receives and stores said air. The bagpipe comprises at least one drone (30) which forms sound using the air from the bag. The drone (30) includes a drone base (35) which fits into a drone stock body (40) which is open to the bag. An electric pickup device (45) having a drone sensor (50) which is spaced 0.5-5 mm from the drone reed (42). The electric pickup device (45) includes a wire (55) which transmits an audio signal, and a cable (60) connected to the wire to output the audio signal. The bagpipe also comprises a chanter (65) which forms sounds using the air from the bag. The chanter includes a chanter body (70) and a reed seat (75) holding a chanter reed (80); and an electric pickup device (85) within the chanter (65). The electric pickup device includes a chanter sensor (92) spaced 0.5-5 mm from the chanter reed (80), a wire (95) enclosed within a cable (100) which leads to a mono plug. The wire transmits an audio signal. Preferably, the drone sensor (50) and chanter sensor (92) are piezoelectric.

Preferably, the bagpipe comprises at least two drones. Most preferably, the bagpipe comprises at least three drones.

In a preferred embodiment the chanter sensor (92) is spaced 1-4 mm from the chanter reed (80) and the drone sensor (50) is spaced 1-4 mm from the drone reed (42).

The present invention also includes an electric pickup device for a bagpipe drone comprising an electric pickup device (45) having a drone sensor (50) spaced 0.5-5 mm from a drone reed tongue (41). The electric pickup device (45) includes a wire (55) to transmit the audio signal from the drone sensor (50) based on the vibrations in the drone reed (41). The wire is encased in a cable (60) which leads to a mono plug to output the audio signal. Preferably, the drone sensor (50) is spaced 1-4 mm apart from the drone reed tongue (41). Most preferably, the drone sensor (50) is spaced 1.5-2 mm apart from the drone reed tongue (41). In a preferred embodiment, the wire (55) is embedded into a reed seat (43).

The present invention also includes an electric pickup device for a bagpipe chanter (65) comprising a chanter reed (80) secured in a reed seat (75) and a chanter sensor (92) fixed to the reed seat (75) which detects vibrations on the chanter reed (80). The chanter sensor (92) is spaced 0.5-5 mm from the chanter reed (80). A wire (95) encased in a cable (100) transmits an audio signal from the chanter sensor (92) based on the vibrations in the chanter reed (80). The wire/cable leads to a mono plug which outputs the audio signal. Preferably, the chanter sensor (92) is spaced 1-4 mm from the chanter reed (80) and the wire (95) is embedded into a reed seat (75). Most preferably, the chanter sensor (92) is spaced 1.5-3 mm from the chanter reed (80).

### DETAILED DESCRIPTION OF THE INVENTION

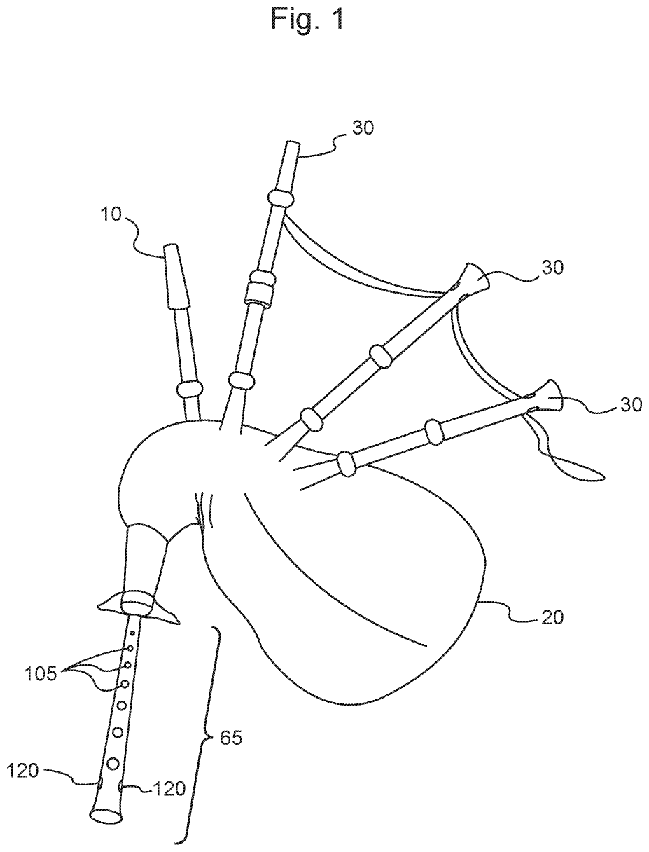

FIG. 1 depicts a traditional bagpipe consisting of an air reservoir or bag (20), a blowstick (10) (or bellows) for filling the bag with air, one or more drone pipes (30), each with an associated drone reed (42), and a chanter pipe (65) with an associated chanter reed (80). The instrumentalist blows air into the bag through the blowpipe and squeezes the air out of the bag into the drone and chanter pipes which are all attached to the bag via connecting pipes called stocks. Each drone and chanter pipe contains a reed within the stock over which air passes as it escapes the bag out through the pipes. The passage of air over the reeds causes the reeds to vibrate and produce sound, which is in turn altered by the either the length of each drone pipe or by the hole placement in the case of the chanter pipe.

The chanter is the melody portion of a bagpipe. The chanter consists of holes (105) which the instrumentalist covers with their fingers to create notes by changing the pitch at which the reed (80) vibrates, thus producing different tones or notes.

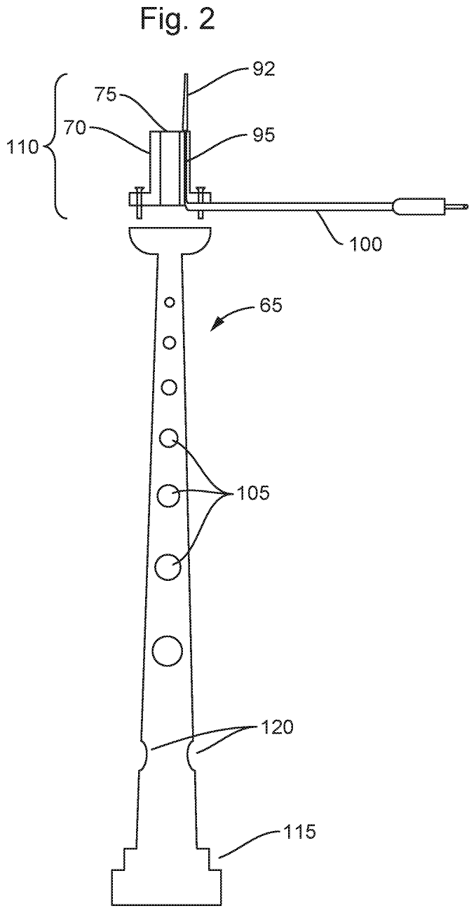

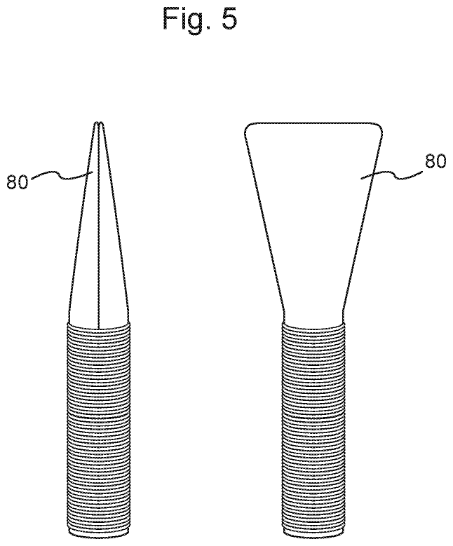

Placement of the chanter sensor depends on the desired sound effect and on the selection of the reed. FIG. 2 depicts a chanter embodiment of the present invention in which the chanter sensor has a slightly bent tip. In this embodiment the majority of the sensor is spaced from 0.5-5 mm away from the reed and the bent tip is spaced closer the reed. In a preferred embodiment the bent tip does not touch the reed but it is bent so that the tip is closer to the reed than the rest of the sensor. In certain embodiments the chanter sensor is parallel to the length of the chanter reed. In certain embodiments the bent tip actually makes slight contact with the reed. .As shown in FIG. 5, a chanter reed (80) is typically a double reed consisting of two pieces of cane which vibrate against each other to create sound when air is blown over the reed. Chanter reeds may also be made from synthetic materials. The reed is placed into a reed seat (75) located in the top portion of a chanter (65), as shown in FIG. 2.

The pitch does not originate from the air coming through the holes (105) on the chanter. The source of pitch variation is coming from the reed itself. The distance between the reed and the hole (105) locations on the chanter as air passes through the reed changes the frequency at which the reed vibrates, thus producing different notes.

Chanter notes are higher pitched than the drone notes, thus, a piezo transducer with a higher resonant frequency is better matched. Most piezoelectric pickups range between 1 and 6 KHz, In a preferred embodiment, the chanter piezoelectric pickups ranges between 3 and 5.5 KHz. In a particularly preferred embodiment a piezoelectric chanter pickup with a frequency 4.6 kHz (+/−0.5 kHz) was found to produce excellent sound. By placing a chanter sensor (92) in slight contact with the reed itself or, in a preferred embodiment, within 0.5-5 mm apart from the reed, the vibrations of the chanter reed (80) are converted into an electrical audio signal. This electrical audio signal can then be amplified and altered according to the instrumentalist's preference. Because the double reed needs to be able to vibrate freely in order to produce sound, the placement of the chanter sensor (92) is important. The chanter sensor (92), being a contact microphone, must come into contact with the source of vibration (e.g., the cane of the reed) or be spaced very close to the vibration source. In certain embodiments of the present invention, the bent tip of the chanter sensor (92), is designed to make as little contact with the reed as possible so as not to interfere with reed vibrations.

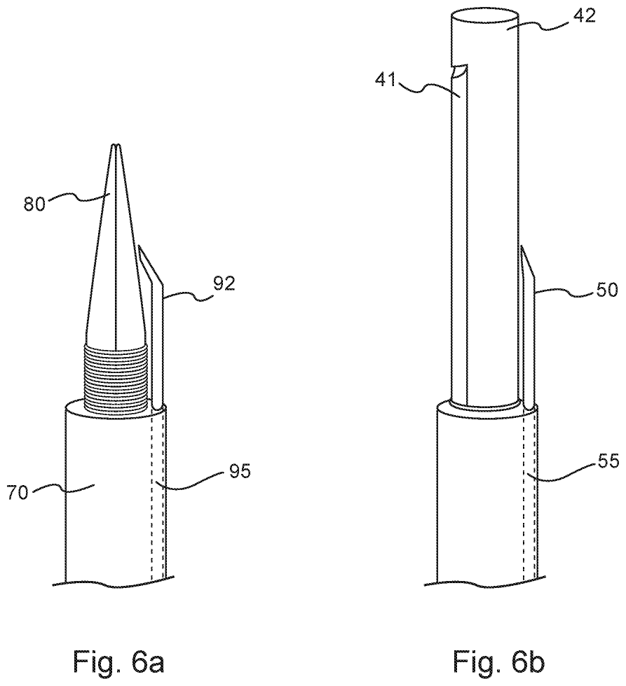

The chanter sensor (92) used to create the electric audio signal is typically a thin disc consisting of a ceramic material adhered to a soft metal such as brass. Preferably, the chanter sensor is between 0.3 and 0.6 mm thick. Most preferably, the chanter sensor is between 0.42 and 0.58 mm thick. Other well-known sensor materials may also be used. By bending the tip of the metal portion of the disc, the piezoelectric transducer can be positioned near the reed without obstructing the reed's ability to vibrate freely as long as only the bent tip of the sensor touches the reed. In certain embodiments, the bent tip of the sensor is slightly spaced apart from the reed. See, for example, FIG. 6a.

FIG. 5 depicts a traditional double chanter reed (80). As shown, the chanter reed is larger at the base and narrows towards the top portion. Thus, in certain embodiments, the entire chanter sensor (92) is bent such that the length of the sensor follows the length of the reed with an even spacing between the sensor and the reed along the length of the reed.

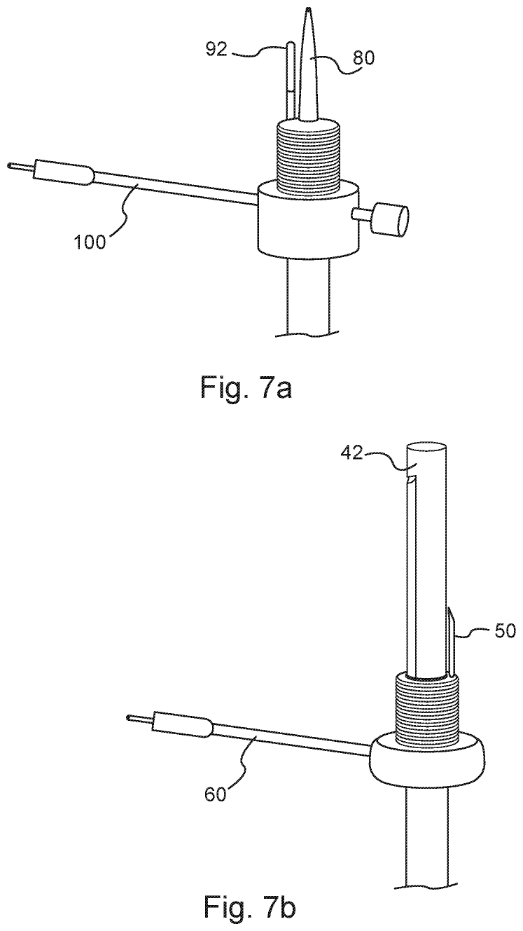

In certain embodiments, the sensor is attached to the base and is straight. See for example, FIG. 7a. In such embodiments the gap between the sensor and the reed will vary along the length of the reed from e.g., between 0.5 to 5 mm. The gap will be smaller at the base and larger towards the top of the reed.

Bagpipe drone reeds have typically been produced from a hollow piece of cane tubing which is sealed at one end and open at the opposing end. A “tongue” or elongated three-sided flap of cane is cut into the cane. The length of the tongue is altered by means of a bridle which girdles the body of the reed and can be moved upward or downward to change pitch. While a drone reed is most commonly a cylindrically-bored tube with a single reed, drones with double reeds exist. GB190814366A, US2003075035A, US2014331849A, U.S. Pat. No. 5,959,226A and GB2376559A depict and describe variations on drone reeds.

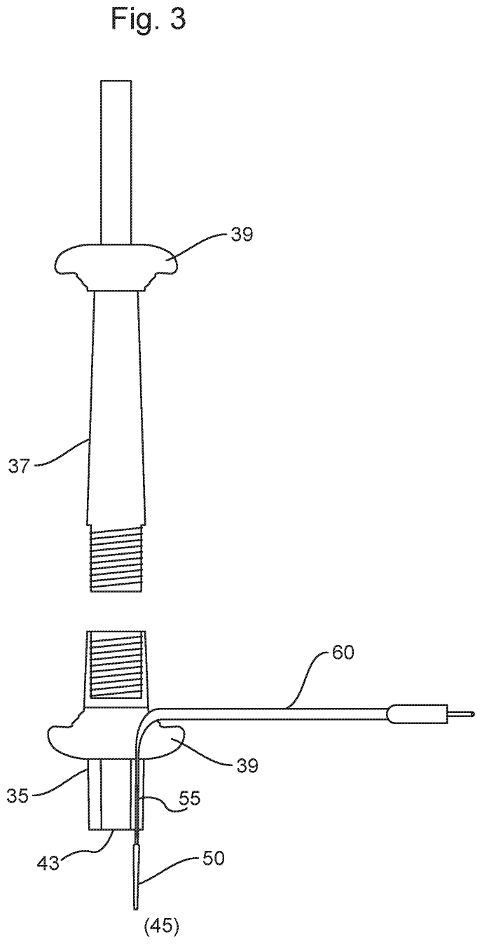

FIG. 3 depicts a preferred drone embodiment of the present invention. As seen, a drone base top (37) is adapted to be removably engaged (by threads) from the drone base (35). However, in certain embodiments the joints between removable portions may have traditional hemp twine seals. In the case of the drone the wire (55) which leads from the drone sensor (50) leads thru a hole in the drone base (35) and a projecting mount (39) to a cable (60). However, in certain embodiments the wire and cable are mounted to the outside surface of the drone base (35).

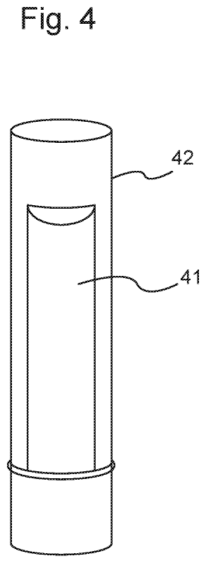

FIG. 4 depicts a traditional drone reed (42). The passage of air over the drone reed (42) causes the drone reed tongue (41) to vibrate and produce sound. Modern drone reeds are often made of synthetic materials which tend to be thicker than natural cane reeds. The optimal gap between the reed and the sensor will depend on the type of reed, the type of sensor and the desired sound. For example, in a typical cane reed an optimal space between the reed and the drone sensor is typically 2-3 mm. In a typical synthetic reed the space between the reed and the drone sensor is smaller and for some reeds it is preferable that the drone sensor is actually slightly touching the reed.

Drone notes are lower pitched, thus a drone sensor with a lower resonant frequency often sounds best. Piezoelectric pickups often range between 1 and 6 KHz. In a preferred embodiment the drone pickup is between 1 and 3 kHz (+/−0.3 kHz). in a most preferred embodiment, a piezo pickup with a frequency 2.2 kHz (+/−0.3 kHz) produced excellent sound. In general a drone sensor which is piezo electric and between 0.4-0.6 thick produces the best sound. Preferably, the piezo electric sensor is between 0.5-0.7 mm thick. Most preferably, the piezo electric sensor is between 0.55-0.65 mm thick.

Placement of the drone sensor depends on the desired sound effect and on the selection of the reed. Some drone reeds are made of synthetic body with a synthetic tongue (e.g., carbon fiber or polycarbonate). Reeds are also typically made of wood (e.g. redwood) or cane. Thus, if a synthetic tongue is used the sensor may be placed closer to the reed.

FIG. 6a shows an embodiment of the present invention where the chanter sensor (92) is slightly bent at the tip so that the tip is closer to the reed. In some embodiments the tip actually makes slight contact with the chanter reed. In other embodiments, the bent tip is placed just shy of touching the reed. FIG. 7a shows embodiment of the present invention where the chanter sensor (92) is spaced apart from the chanter reed (80). In another preferred embodiment, the chanter sensor is spaced 0.5-5 mm away for the reed. Preferably, the chanter sensor is spaced 1-4 mm away from the chanter reed. Preferably the chanter sensor is made of a Brass/Ceramic material. Although, other sensor materials may also be used such as, for example, single-crystal materials (such as quartz, gallium-phosphate, tourmaline, etc). Ceramic materials are more sensitive but less stable over time whereas single crystal based sensors are less sensitive but more stable over time.

FIG. 6b shows embodiment of the present invention where the drone sensor (50) is slightly spaced from the drone reed (42). Depending on the desired sound, the sensor can be placed on the side of the reed opposing the tongue or on the tongue side of the reed. Preferably the drone sensor is made of a Brass/Ceramic material. Although, other sensor materials may also be used such as, for example, piezoelectric ceramics (such as PZT ceramic), single-crystal materials (such as quartz, gallium-phosphate, tourmaline, etc). Ceramic materials are more sensitive but less stable over time whereas single crystal based sensors are less sensitive but more stable over time.

Preferably, the drone sensor is between 0.4 and 0.6 mm thick. Most preferably, the drone sensor is between 0.5 and 0.7 mm thick. FIG. 7b shows embodiment of the present invention where the drone sensor (50) is spaced apart from a drone reed (42). In a preferred embodiment, the drone sensor (50) is spaced 0.5-5 mm away for the drone reed. Preferably, the drone sensor (50) is spaced 1-4 mm away from the drone reed. In some embodiments the drone sensor is bent so that the tip of the sensor is closer to the reed than the base of the sensor.

In certain embodiments the piezoelectric sensor is soldered to two 26 gauge wires contained within the drone or chanter. To protect the wires which exit the drone or chanter the wires are covered with cable material such as, for example, heat-shrink plastic wrap. In preferred embodiments the ends of the wires are soldered to a ⅛″ (3.5 mm) mono ‘male’ plug. To connect the sensor to an external amplification device, a cable adapter may be necessary. The preferred cable adapter is a mono ‘female’ ⅛″ to a mono ‘female’ ¼″ adapter. The adapter is secured to the drone or chanter stock using, for example, a metal hose clamp or bound to the stock with twine. A ¼″ instrument cable of varying length can be connected to the adapter and fed into an amplification device. Alternatively, if connecting into a computer or other smaller device a cable with a ⅛″ mono ‘female’ jack leading to a ⅛″ mono ‘male’ plug may be used. This type of cable can be directly fitted to the plug coming out of the bagpipe and no adapter is necessary. An adapter may be necessary for ¼″ connections which are more typical in guitar and live instrument amplification.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

### EXAMPLE

### Example 1

A thicker piezo disc is used for the drone sensor which has a lower resonant frequency. A thinner smaller diameter piezo discs is used for the chanter pickup.

### Drone Piezo Pickup:

The frequencies of the notes that the drone reeds produce are between 116 Hz and 233 Hz. Thus, a 41 mm piezo disc with a resonant frequency of 2.2 kHz produced an excellent sound for transducing these notes.
Frequency: 2.2 kHz (+/−0.3 kHz)
Dimensions: 41 mm Disc (cut into 15 mm wide strip)
Material: Brass/Ceramic
Thickness: 0.63 mm
Lead Wires: 26 gauge
Lead Wire Overall Length: 9 to 12 inches
Space between sensor and reed: 2 mm
The backside of the sensor (i.e., the side placed away from the reed) is coated with epoxy to protect the sensor.

### Chanter Piezo Pickup:

The frequencies of the notes that the chanter reed produces are between 466 and 932 Hz. Thus, a 27 mm piezo disc with a resonant frequency of 4.6 kHz produced an excellent sound for transducing these notes.
Frequency: 4.6 kHz (+/−0.5 kHz)
Dimensions: 27 mm Disc (cut into 15 mm wide strip)
Material: Brass/Ceramic
Thickness: 0.54 mm
Lead Wires: 26 gauge
Lead Wire Length from Chanter (Excluding Plug): 3 inches
Lead Wire Overall Length: ˜5 inches
Space between sensor and reed: 2 mm
The backside of the sensor (i.e., the side placed away from the reed) is coated with epoxy to protect the sensor.

The entire disclosures of all applications, patents and publications, cited herein and of U.S. Provisional Application Ser. No. 62/834,142 filed 18 Apr. 2019, is incorporated by reference herein.

The preceding example can be repeated with similar success by substituting the generically or specifically described components of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

We claim:

1. A bagpipe comprising:
a blowstick (10) for delivering air to a bag (20) which receives and stores said air;
at least one drone (30) to form sounds using the air from the bag; the drone (30) including a drone base (35) which fits into a drone stock body (40) which is open to said bag;
a first electric pickup device (45) having a drone sensor (50) spaced 0.5-5 mm from the drone reed (42),
the first electric pickup device (45) including a wire (55) to transmit the audio signal, said wire leads to and is encased in a cable (60) to output the audio signal;
a chanter (65) also to form sounds using the air from the bag, the chanter including a chanter body (70) and a reed seat (75) holding a chanter reed (80); and
a second electric pickup device (85) within the chanter (65), the second electric pickup device including
a chanter sensor (92) spaced 0.5-5 mm from the chanter reed (80),
a wire (95) to transmit an audio signal, said wire leads to and is encased in
a cable (100) to output the audio signal.

2. The bagpipe of claim 1, wherein said drone sensor (50) and chanter sensor (92) are piezoelectric.

3. The bagpipe of claim 1, comprising at least two drones.

4. The bagpipe of claim 1, wherein the chanter sensor (92) is spaced 1-4 mm from the chanter reed (80).

5. The bagpipe of claim 1, wherein the drone sensor (50) is spaced 1-4 mm from the drone reed (42).

6. An electric pickup device for a bagpipe drone, the electric pickup device comprising:
a first electric pickup device (45) having a drone sensor (50) spaced 0.5-5 mm from a drone reed tongue (41),
the first electric pickup device (45) including a wire (55) to transmit the audio signal from the drone sensor (50) based on the vibrations in the drone reed (41), and a cable (60) encasing said wire to output the audio signal.

7. The bagpipe of claim 6, wherein the drone sensor (50) spaced 1-4 mm from the drone reed tongue (41).

8. The bagpipe of claim 6, wherein the wire (55) is embedded into a reed seat (43).

9. An electric pickup device for a bagpipe chanter, the electric pickup device comprising:
a chanter reed (80) secured in a reed seat (75) for use within the chanter (65);
a chanter sensor (92) to detect vibrations on the chanter reed (80) and fixed to the reed seat (75), wherein the a chanter sensor (92) is spaced 0.5-5 mm from the chanter reed (80);
a wire (95) to transmit an audio signal from the chanter sensor (92) based on the vibrations in the chanter reed (80); and
a cable (100) encasing said wire (95) to output the audio signal.

10. The bagpipe of claim 9, wherein the chanter sensor (92) is spaced 1-4 mm from the chanter reed (80).

11. The bagpipe of claim 9, wherein the wire (95) is embedded into a reed seat (75).

12. The electric pickup device of claim 6, wherein the drone sensor is piezoelectric between 1.5 and 3 KHz and between 0.55 and 0.7 mm thick.

13. The electric pickup device of claim 9, wherein the chanter sensor is piezoelectric between 3 and 6 KHz and between 0.42 and 0.58 mm thick.

14. The bagpipe of claim 1, wherein the drone sensor is piezoelectric between 1.5 and 3 KHz and the chanter sensor is piezoelectric between 3 and 6 KHz.
